(19) United States
(12) Patent Application Publication
(10) Pub. No.: US 2015/0077696 A1
(43) Pub. Date: Mar. 19, 2015

(54) EYEWEAR

(71) Applicant: JIN CO., LTD., Gunma (JP)

(72) Inventor: Hitoshi TANAKA, Tokyo (JP)

(21) Appl. No.: 14/488,233

(22) Filed: Sep. 16, 2014

(30) Foreign Application Priority Data
Sep. 17, 2013 (JP) 2013-192035
Nov. 27, 2013 (JP) 2013-245150

(51) Int. Cl. G02C 11/08

(52) U.S. Cl. CPC G02C 11/08
USPC 351/62

(57) ABSTRACT

Eyewear includes: a liquid retainer including a cavity to retain a liquid; and a frame in which a housing is formed to house at least a part of the liquid retainer, where the liquid retainer is supported to the frame via a hinge, to be movable between a position at which the liquid retainer is housed in the housing and a position at which the liquid retainer is not housed in the housing, and the liquid retainer includes a gaseous body transmission member transmitting a gaseous body from the cavity towards a face when the liquid retainer is housed in the housing and the frame is worn on the face.

### CROSS REFERENCE TO RELATED APPLICATION

The contents of the following Japanese patent applications are incorporated herein by reference:

NO. 2013-192035 filed on Sep. 17, 2013, and

NO. 2013-245150 filed on Nov. 27, 2013.

### BACKGROUND

1. Technical Field

The present invention relates to eyewear.

2. Related Art

There are glasses known for preventing allergies and dry eye, and these glasses have a frame that includes a humidifier having a container that houses a liquid holding component. For example, see Patent Documents 1 to 3.
Patent Document 1: Japanese Patent Application Publication No. 2000-005215
Patent Document 2: Japanese Utility Model Registration No. 3152412
Patent Document 3: Japanese Design Registration No. 1069214

### SUMMARY

However, there is a problem that a member retaining a liquid is easily removed from the frame.

So as to solve the above-stated problem, according to the first aspect of the present invention, provided is eyewear including: a liquid retainer including a cavity to retain a liquid; and a frame in which a housing is formed to house at least a part of the liquid retainer, where the liquid retainer is supported to the frame via a hinge, to be movable between a position at which the liquid retainer is housed in the housing and a position at which the liquid retainer is not housed in the housing, and the liquid retainer includes a gaseous body transmission member transmitting a gaseous body from the cavity towards a face when the liquid retainer is housed in the housing and the frame is worn on the face.

The above and other objects can be achieved by combinations described in the independent claims. The dependent claims define further advantageous and exemplary combinations of the innovations herein.

### BRIEF DESCRIPTION OF THE DRAWINGS

FIG. 1 is a schematic view of exemplary glasses 100.

FIG. 2 schematically shows glasses 100 whose liquid container 130 is housed in the opening 140.

FIG. 3 schematically shows a perspective development view of the glasses 100.

FIG. 4 schematically shows a perspective view of the liquid container 130.

FIG. 5 schematically shows a perspective view of the liquid container 230 according to another embodiment.

FIG. 6 schematically shows a perspective view of the liquid container 330 according to another embodiment.

FIG. 7 schematically shows a frame 420 and a liquid container 430 according to another embodiment.

FIG. 8 schematically shows the frame 420 in a folded state.

FIG. 9 schematically shows the frame 420 in an unfolded state.

FIG. 10 schematically shows a perspective development view of the frame 420 and the liquid container 430.

FIG. 11 schematically shows a state in which the liquid container 430 is removed from the frame 420.

FIG. 12 schematically shows a frame 720 and a liquid container 730 according to another embodiment of the glasses 100.

FIG. 13 schematically shows a state in which the liquid container 730 is removed from the frame 720.

FIG. 14 is a perspective view of a lid 737.

FIG. 15 is a perspective view of the lid 737.

### DESCRIPTION OF EXEMPLARY EMBODIMENTS

Hereinafter, some embodiments of the present invention will be described. The embodiments do not limit the invention according to the claims, and all the combinations of the features described in the embodiments are not necessarily essential to means provided by aspects of the invention. In addition, the embodiments are described with reference to the drawings. In the drawings, the same or similar portions are assigned the same reference numeral, and overlapping explanation may be occasionally omitted. The drawings are schematic views, and do not indicate the actual dimensions of the embodiments. For ease of explanation, different drawings may include portions in different scales.

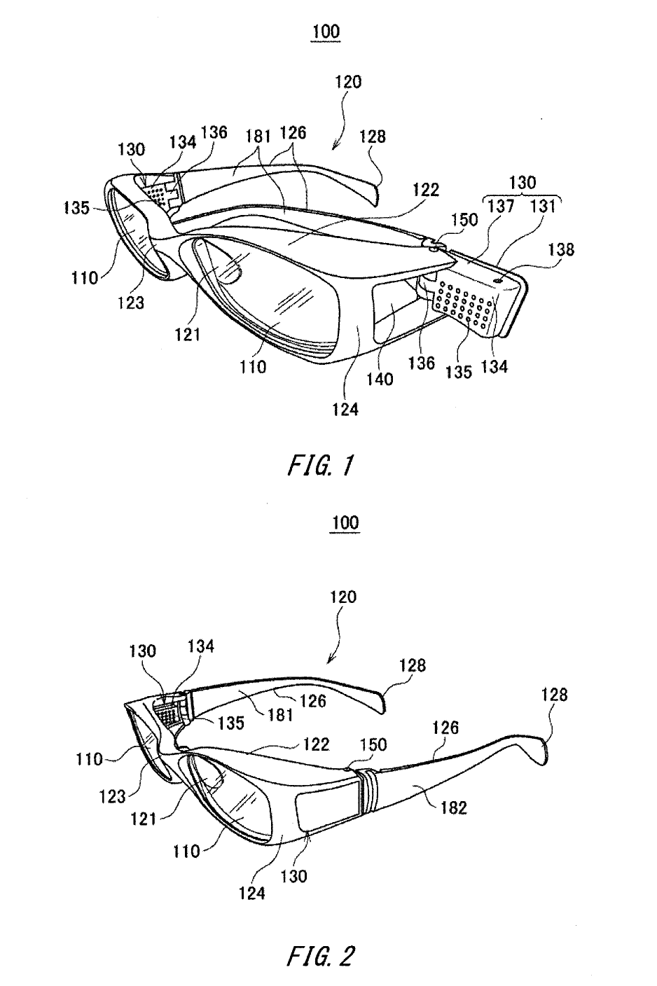

FIG. 1 is a schematic view of exemplary glasses 100 according to an embodiment. The glasses 100 include a pair of lenses 110, a frame 120, and liquid containers 130. The glasses 100 and the frame 120 are an example of eyewear. The glasses 100 are equipment to be worn by a wearer around his or her eyes.

The liquid container 130 is an example of a liquid retainer for retaining a liquid. An opening 140 is provided through a part of the frame 120. At least a part of the liquid container 130 may be housed in the opening 140. The opening 140 is an example of a housing in which at least a part of the liquid container 130 is housed. As detailed later, the liquid container 130 is supported by the frame 120 via a hinge, to be movable between a position at which the liquid container 130 is housed in the opening 140 and a position at which the liquid container 130 is not housed in the opening 140. FIG. 1 schematically shows glasses 100 in the state in which the liquid container 130 is not housed in the opening 140.

FIG. 2 schematically shows glasses 100 whose liquid container 130 is housed in the opening 140. A plurality of air holes 135 are formed on the side surface 134 in the liquid container 130, being a surface to face a face of the wearer when the liquid container 130 is housed in the opening 140 and the frame 120 is worn on the face of the wearer. The air holes 135 penetrate up to the later-described cavity 132, and transmit gaseous body but does not transmit a liquid. The liquid retained in the liquid container 130 is vaporized to be provided towards the face of the wearer through the air holes 135. Therefore, the glasses 100 can be used as measure to prevent dry eye. The glasses 100 can also be used as measure against allergies, in addition to or instead of measure to prevent dry eye.

The frame 120 includes a nose pad 121, a rim 122, a bridge 123, an end piece portion 124, a hinge spindle member 150, a temple 126, and an ear band 128. The nose pad 121 contacts the nose of the face of the wearer when the frame 120 is worn on the face of the wearer. When the frame 120 is worn on the face of the wearer, the nose pad 121 positions the frame 120 relative to the face of the wearer. The bridge 123 is positioned between the pair of rims 122.

The rim 122 holds the lens 110. The lens 110 may be a lens for correcting refractive error of the eye of a wearer. Examples of the lens 110 may be lens for correction of near-sightedness, lens for correction of far-sightedness, or the like. The lens 110 is an example of the optical component held by the rim 122. The optical component has an optical characteristic suited for the application as glasses 100. For example, the optical component may have a wavelength selection characteristic of selectively transmitting light of a specific wavelength region, in addition to the function of a lens. Note that the optical component may not include a lens function. For example, the refractive power of the optical component may be substantially 0. In this case, the refractive error of eyes of the wearer will not be substantially corrected. In other words, the eyesight of the wearer will not be corrected.

The rim 122 includes a hood member elongating towards the wearer from around the lens 110. Accordingly, the gaseous body evaporated from the liquid container 130 can be restrained from diffusing. The end piece portion 124 also called an end piece is provided at the end of the rim 122, and is connected to the temple 126 via the hinge spindle member 150. The pair of temples 126 sandwich the head of a wearer. The ear band 128 is positioned at the tip of the temple 126. At least a portion of the ear band 128 contacts the wearer near his or her ear, when the frame 120 is worn. The ear band 128 may be a pad member covering at least a portion of the temple 126.

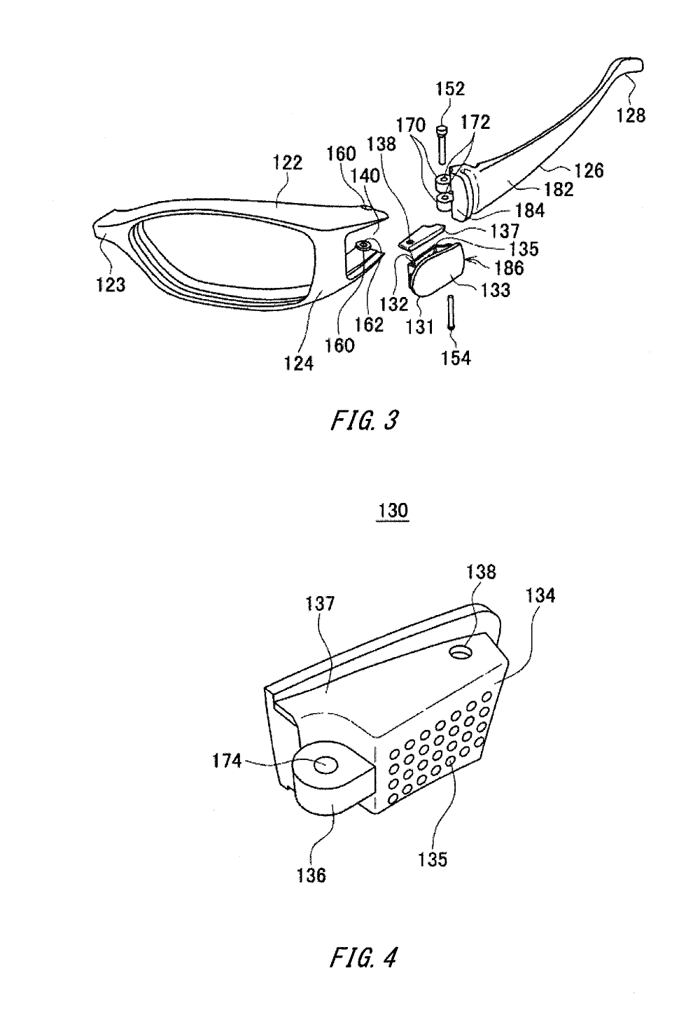

FIG. 3 schematically shows a perspective development view of the glasses 100. FIG. 3 schematically shows a perspective development view of the glasses 100 from the left eye side of the bridge 123. FIG. 4 schematically shows a perspective view of the liquid container 130. The liquid container 130 includes a container main body 131 and a lid 137.

A cavity 132 for retaining a liquid is formed inside the liquid container 130. The cavity 132 can accumulate a liquid. An example of the liquid retained in the cavity 132 is water. The inside of the cavity 132 may be processed to be water repellent. The inside of the cavity 132 may be antimicrobial-impregnated.

An opening for supplying a liquid in the cavity 132 when the liquid container 130 is not housed in the opening 140 is formed through the liquid container 130. The opening is formed in a position facing the inner surface of the opening 140 when the liquid container 130 is housed in the opening 140. Specifically, the opening is formed on the upper portion of the liquid container 130.

The lid 137 seals the upper opening of the liquid container 130. An insertion opening 138 is formed through the lid 137. The insertion opening 138 is an example of a liquid supply port penetrating from outside to the cavity 132. A liquid injection tool such as a dropper can be inserted through the insertion opening 138. The liquid injection tool can be inserted through the insertion opening 138 when the liquid container 130 is not housed in the opening 140, to supply a liquid from the liquid injection tool to the cavity 132. For example, the insertion opening 138 has a circular shape whose section has a diameter of 1.5 mm.

The lid 137 may be formed by soft resin. The lid 137 may be formed by a material having elasticity higher than elasticity of the material forming the container main body 131. The material of the lid 137 may be elastomer such as crude rubber, synthetic rubber, silicone rubber, or the like. In this case, when the liquid container 130 is housed in the opening 140 of the frame 120, the lid 137 provided between the inner surface of the opening 140 and the liquid container 130 will press them, to make it hard to remove the liquid container 130 from the opening 140.

The lid 137 may be provided to be removable with respect to the upper opening of the liquid container 130. A user can remove the lid 137 from the upper opening of the liquid container 130 when the liquid container 130 is not housed in the opening 140. Because the lid 137 can be removed to expose the opening, a liquid can be supplied through the exposed opening to the cavity 132 without using any liquid injection tool. In addition, the liquid retained in the cavity 132 can be discharged to outside through the exposed opening from the cavity 132. Therefore, the liquid retained in the cavity 132 can be easily exchanged.

The liquid container 130 is linked to the frame 120 by means of the hinge spindle member 150. Specifically, the liquid container 130 is linked to the end piece portion 124 by means of the hinge spindle member 150. More specifically, the liquid container 130 is supported with respect to the end piece portion 124 to be movable, by means of the hinge spindle member 150. The container main body 131 of the liquid container 130 includes an insertion member 136 to which the hinge spindle member 150 is inserted. The hinge spindle member 150 is inserted to the insertion opening 174 of the insertion member 136.

The rim 122 is provided with the insertion member 160 through which the hinge spindle member 150 is inserted. An insertion opening 162 of the insertion member 160 is inserted through the hinge spindle member 150. The temple 126 is provided with the insertion member 170 through which the hinge spindle member 150 is inserted. The hinge spindle member 150 is inserted through the insertion opening 172 of the insertion member 170. In this way, the hinge spindle member 150 is inserted through the insertion opening 162, the insertion opening 172, and the insertion opening 174. The hinge spindle member 150 includes a shaft member 152 inserted from the upper insertion member 160, and a shaft member 154 inserted from the lower insertion member 160. The shaft member 154 and the shaft member 152 include an insertion member to insert to each insertion opening and a head portion larger than the insertion opening 162. The shaft member 154 is assembled so that at least a part of the insertion member of the shaft member 154 is housed in the insertion member of the shaft member 152. The insertion member of the shaft member 152 is inserted through the respective insertion opening, to be assembled to the end piece portion 124 as a hinge spindle member 150 together with the shaft member 154.

The hinge spindle member 150 and the insertion member 136 provide a hinge mechanism supporting the liquid container 130 with respect to the frame 120 movably. This hinge mechanism supports, to be movable, the liquid container 130 with respect to both the end piece portion 124 and the temple 126. Specifically, the liquid container 130 rotates independently around the hinge spindle member 150, with respect to the temple 126 and the end piece portion 124. Therefore, the liquid container 130 can rotate around the hinge spindle member 150 and can move between a position housed in the opening 140 and a position not housed in the opening 140. In this way, the hinge mechanism supports the liquid container 130 to the frame 120 to be movable between the position at which the liquid container 130 is housed in the opening 140 and the position at which the liquid container 130 is not housed in the opening 140. For this reason, the liquid container 130 can be supported to the frame in a manner in which the liquid to be retained in the liquid container 130 can be injected and exchanged easily. In addition, the liquid container 130 is hard to remove from the frame 120, which reduces a possibility of losing the liquid container 130.

The hinge spindle member 150 and the insertion member 170 provide a hinge mechanism supporting the temple 126 to the end piece portion 124 movably. This hinge mechanism enables the temple 126 to be movably supported to the end piece portion 124 between the state in which the temple 126 is folded with respect to the end piece portion 124 and the state in which the temple 126 is not folded with respect to the end piece portion 124 as the left temple 126 of FIG. 2 shows.

In this way, the opening 140 is formed on the end piece portion 124 of the frame 120, and the temple 126 is supported movably with respect to the end piece portion 124, via the hinge. The liquid container 130 and the temple 126 are rotatably supported by the hinge around the common hinge spindle member 150. Consequently, the spindle of the hinge can be shared, to be able to reduce the number of parts compared to the case in which the spindle of the hinge is not shared. It is possible to make a smaller hinge mechanism compared to the case in which the spindle of the hinge is not shared, as well as maintaining a space retaining the liquid wider.

The above-explained hinge mechanism enables the liquid container 130 and the temple 126 to independently rotate around the hinge spindle member 150. For example, it is possible to fold the temple 126 with respect to the end piece portion 124, while the liquid container 130 is housed in the opening 140. Even by folding the temple 126 with respect to the end piece portion 124, the liquid container 130 does not move easily with respect to the end piece portion 124. By rotating the liquid container 130 around the hinge spindle member 150 while the temple 126 is folded with respect to the end piece portion 124, it is possible to remove out the liquid container 130 from the opening 140.

If the temple 126 is not folded with respect to the end piece portion 124, the end-piece-portion-side side surface 184 of the temple 126 abuts against the temple-side side surface 186 of the container main body 131 of the liquid container 130. Therefore, if the temple 126 is not folded with respect to the end piece portion 124, the liquid container 130 will not be easily removed from the opening 140. Therefore, when the glasses 100 are worn by a wearer, the liquid container 130 will not be easily removed from the opening 140.

When the liquid container 130 is housed in the opening 140, the liquid container 130 has a side surface 134 and a side surface 133 opposite to the side surface 134, where the side surface 134 will be provided to face the face when the frame 120 provided with the liquid container 130 is worn on the face. The side surface 134 and the side surface 133 may have a form conforming to the side surface of the frame 120. For example, the side surface 134 and the side surface 133 may have a form conforming to the side surface of the end piece portion 124. The side surface 133 may have a form conforming to the outer surface 182 of the temple 126. The side surface 134 may have a form conforming to the inner surface 181 which is a surface opposite to the outer surface 182 in the temple 126. The side surface 134 and the side surface 133 may be provided in the frame 120 more inner than the corresponding side surface of the frame 120. The side surface 133 has a form conforming to the outer side surface of the end piece portion 124, and the side surface 134 may be provided inner than the inner side surface of the end piece portion 124

The air holes 135 of the glasses 100 are provided in matrix formation of 4 rows and 7 columns on the side surface 134. The air hole 135 is an example of the gaseous body transmission member causing a gaseous body to pass from the cavity 132 to the face, when the liquid container 130 is housed in the opening 140 and the frame 120 is mounted on the face. Specifically, the air hole 135 does not cause a liquid to pass from the cavity 132 to the side surface 134, but cause a gaseous body to pass. In an example, a section form of the air hole 135 parallel to the side surface 134 is circular having a diameter of 1 mm.

Accordingly, a liquid is restrained from being leaked from the air hole 135. For example, a liquid leaking from the air hole 135 is restrained even if the air hole 135 is not covered with water retentive or water absorbing materials such as felt, paper, sea sponge, sponge, water absorptive polymer, and hydrogel, or if the cavity 132 is not covered with a filler material made of water retentive or water absorbing materials. Therefore, it becomes possible to accumulate a liquid inside the liquid container 130 without using any filler material. Consequently, compared to a case in which the entire inside of the liquid container 130 is filled with a filler material, more liquid in quantity can be accumulated. Furthermore, even in a case in which the liquid container 130 is not filled with any filler material, a liquid leak from the air hole 135 can be restrained, thereby enabling to use the glasses 100 hygienically.

The liquid container 130 may not have any lid 137. When the liquid container 130 is housed in the opening 140, even without the lid 137, the liquid retained in the cavity 132 can be restrained from leaking outside, if the opening of the cavity 132 can be substantially sealed with the inside of the opening 140.

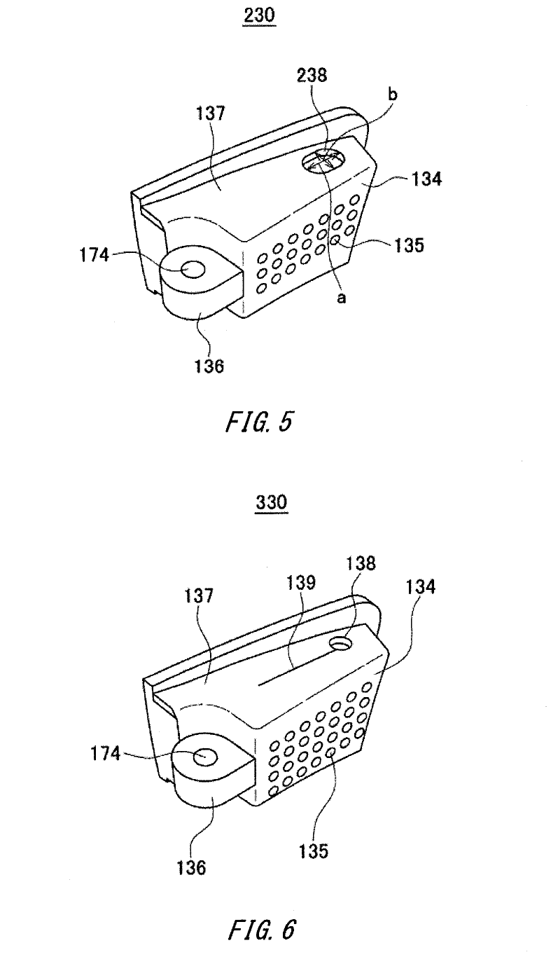

FIG. 5 schematically shows a perspective view of the liquid container 230 according to another embodiment. The members respectively having the same configuration as respective portions of the liquid container 130 are assigned the same reference numerals, and explanation is occasionally omitted.

The air holes 135 are provided in a matrix formation of 3 rows by 7 columns on the side surface 134. An insertion opening 238 is provided through the lid 137. The sectional form of the insertion opening 238 is non-circular. The lengthwise direction of the insertion opening 238 is set as “a”, and the short side direction of the insertion opening 238 is set as “b”. For example, “a” may be 4 mm, and “b” may be 3 mm. In another example, “a” may be 7 mm, and “b” may be 3 mm. Many other combinations of the value of “a” and the value of “b” may be possible. The sectional form of the insertion opening 238 may be ellipsoidal. Many other sectional forms are possible for the insertion opening 238. In addition, the air holes 135 may be provided in a matrix formation of 2 rows by 7 columns on its side surface 134.

FIG. 6 schematically shows a perspective view of the liquid container 330 according to another embodiment. The members respectively having the same configuration as respective portions of the liquid container 130 are assigned the same reference numerals, and explanation is occasionally omitted.

The liquid container 330 includes a container main body 131 and a lid 137. The lid 137 is provided with an insertion opening 138, and a slit 139 linking to the insertion opening 138. Since the lid 137 is provided with a slit 139 inking to the insertion opening 138, it is possible to supply a liquid to the liquid container 130 using various kinds of liquid supply tools.

In the liquid container 230 explained with reference to FIG. 5 or the like, the lid 137 is not provided with any slit corresponding to the slit 139 of the liquid container 330. However, just as the slit 139 of the liquid container 330, a slit linking to the insertion opening 238 can be provided for the lid 137 for the liquid container 230.

Regarding the liquid container 130, the liquid container 230, and the liquid container 330, the sectional form of the air hole 135 was explained to be circular having a diameter of 1 mm. In addition, an example in which a plurality of air holes 135 are provided to be aligned in a matrix formation was explained. However, the form, number, and positioning of the air holes 135 are not limited as explained above. For example, there may be a single air hole 135. In other words, there may be one or more air holes 135. When a plurality of air holes 135 are provided, the plurality of air holes 135 may not be aligned. The form of the air holes 135, as well as the number and positioning thereof may be determined to cause a gaseous body to pass from the cavity 132 to the side surface 134, but not to cause a liquid to pass through.

The form of the air hole 135 may be determined so as to enable water vapor to pass from the cavity 132 to the inner surface of the frame 120, but not to cause any pure water or tap water to pass through. The form of the air hole 135 may be the sectional form of the air hole 135, the size of the section, and the distance for the air hole 135 from the surface towards the cavity 132 to the inner surface of the frame 120, for example. Water-vapor transmission ratio testing method determined by JIS Z0208 (Cup method) and water-vapor transmission ratio testing method determined by JIS K7129 (Lyssy method) may be used to determine whether water vapor transmits through the air hole 135, by measuring the amount of water vapor passing through the test piece. Determination that water vapor passes through the air hole 135 may be done when the water vapor transmission amount when the test piece is provided with the air hole 135 is more than the water vapor transmission amount when the test piece is not provided with the air hole 135.

Determination on whether pure water or tap water transmits through the air hole 135 may be made by determining whether pure water or tap water passes through the air hole 135 when left still for 10 minutes in the state in which the pressure difference of 9.806 Pa or below is caused between the opening of the air hole 135 towards the cavity 132 and the opening of the air hole 135 towards the inner surface of the frame 120. Whether pure water or tap water has passed through the air hole 135 can be determined by confirming leakage of water in liquid form by visual observation. Preferably, the pressure difference may be greater than 9.806 Pa and equal to or below 49.03 Pa, and more preferably, the pressure difference may be greater than 49.03 Pa and equal to or below 98.06 Pa. Still more preferably, the pressure difference may be greater than 98.06 Pa and equal to or below 294.18 Pa.

When the sectional form of the air hole 135 is circular, the diameter of the air hole 135 may be equal to or above 0.1 mm and equal to or below 1.5 mm, preferably equal to or above 0.3 mm and equal to or below 1.2 mm, and more preferably equal to or above 0.5 mm and equal to or below 1 mm. When the sectional form of the air hole 135 is ellipsoidal, the major axis of the air hole 135 may be equal to or above 0.1 mm and equal to or below 1.7 mm, preferably equal to or above 0.5 mm and equal to or below 1.4 mm, more preferably equal to or above 0.7 mm and equal to or below 1.2 mm. The distance from the surface towards the cavity 132 to the inside surface of the frame 120, with respect to the air hole 135, may be equal to or above 0.1 mm and equal to or below 1.5 mm, preferably equal to or above 0.3 mm and equal to or below 1.2 mm, more preferably equal to or above 0.5 mm and equal to or below 1 mm.

The summation of the volumes of the plurality of air holes 135 may be smaller than the volume of the cavity 132. Here, when the filler material is provided inside the cavity 132, the volume of the portion of the inside of the cavity 132 occupied by the filler material is not included in the volume of the cavity 132.

The air hole 135 may be provided above the position corresponding to the water surface when the frame 120 provided with the liquid container 130 is worn on the face. Note that when the size of the air hole 135 is sufficiently small, the air hole 135 may be provided below the position corresponding to the water surface when the frame 120 provided with the liquid container 130 is worn on the face.

According to the above-explained configuration, the gaseous body generated by vaporization of the liquid accumulated in the cavity 132 passes through the air hole 135 to be supplied towards the inner side of the frame 120. In addition, since the air hole 135 does not pass through the liquid accumulated in the cavity 132, scattering of the liquid onto the face of the wearer can be restrained.

In the present embodiment, the air hole 135 is explained to be a gaseous body transmission member. However, the gaseous body transmission member is not limited to this. The gaseous body transmission member may include an organic polymer film or an inorganic porous film causing a gaseous body to permeate but not a liquid. The gaseous body transmission member may include an organic polymer film or an inorganic porous film causing a water vapor to permeate but not pure water or tap water. The gaseous body transmission member may be a silicone rubber. According to this configuration, liquid leak from the air hole 135 can also be restrained. For example, even when the air hole 135 is not covered with water retentive or water absorbing materials, liquid leak from the air hole 135 can be restrained. In this case, more liquid in amount can be accumulated. It is also possible to use the glasses 100 hygienically.

An example in which the glasses 100 are not provided with water retentive or water absorbing materials inside the cavity 132 has been explained. However, the glasses 100 are not limited to this. Water retentive or water absorbing materials such as felt, paper, sea sponge, sponge, water absorptive polymer, and hydrogel may configure a part of the gaseous body transmission member. There may be water retentive or water absorbing materials provided in the cavity 132. Accordingly, even when the size of the air hole 135 is large, liquid leak from the cavity 132 can be restrained. Note that in this case, the upper edge of the water retentive or water absorbing materials is preferably above the liquid surface of the liquid accumulated in the cavity.

When water retentive or water absorbing materials are provided inside the cavity 132, the volume of the inside of the cavity 132 occupied by the water retentive or water absorbing materials may be smaller than half the volume of the cavity 132 in the state in which there is no water retentive or water absorbing material provided in the cavity 132. By doing so, more liquid in amount can be accumulated in the cavity 132.

An example in which the liquid container 130 of the glasses 100 is open/close from the outer surface of the frame 120, and the liquid container 130 moves between the position at which the liquid container 130 is housed in the opening 140 and the position at which the liquid container 130 is not housed in the opening 140 was explained. However, the direction in which the liquid container 130 is open/close is not limited to this. For example, the liquid container 130 may be open/close from the inner surface. The liquid container 130 may further be open/close from both of the outer surface and the inner surface.

An example in which the liquid container 130 of the glasses 100 is housed in the opening 140 of the frame 120 was explained. However, the housing that houses therein the liquid container 130 is not limited to this. For example, the liquid container 130 may be housed in the concave portion formed for the frame 120. For example, the concave portion may be formed on the inner surface or the outer surface of the frame 120, to house the liquid container 130 in the concave portion. For example, the concave portion housing the liquid container 130 may be provided on the inner surface of the frame 120. In this case, the liquid container 130 may be open/close from the inner surface of the frame 120. The concave portion housing therein the liquid container 130 may be formed on the outer surface of the frame 120. In this case, the liquid container 130 may be open/close from the outer surface of the frame 120.

An example in which the housing that houses the liquid container 130 is provided in the end piece portion 124 in the glasses 100 was explained. However, the position of the housing is not limited to this. The housing may be formed in the temple.

An example in which the spindle supporting movably the liquid container 130 with respect to the frame 120 is also used as the spindle supporting movably the temple 126 with respect to the end piece portion 124 in the glasses 100 was explained. However, the mechanism for supporting the liquid container 130 movably to the frame 120 is not limited to this. The liquid container 130 may be supported movably to the frame 120 by the spindle different from the spindle movably supporting the temple 126 with respect to the end piece portion 124. For example, the glasses 100 may include a hinge for movably supporting the liquid container 130 to the frame 120 and a hinge for movably supporting the temple 126 to the end piece portion 124. In addition, the liquid container 130 may be supported movably with respect to the frame 120 by means of a displacement mechanism other than the hinge mechanism.

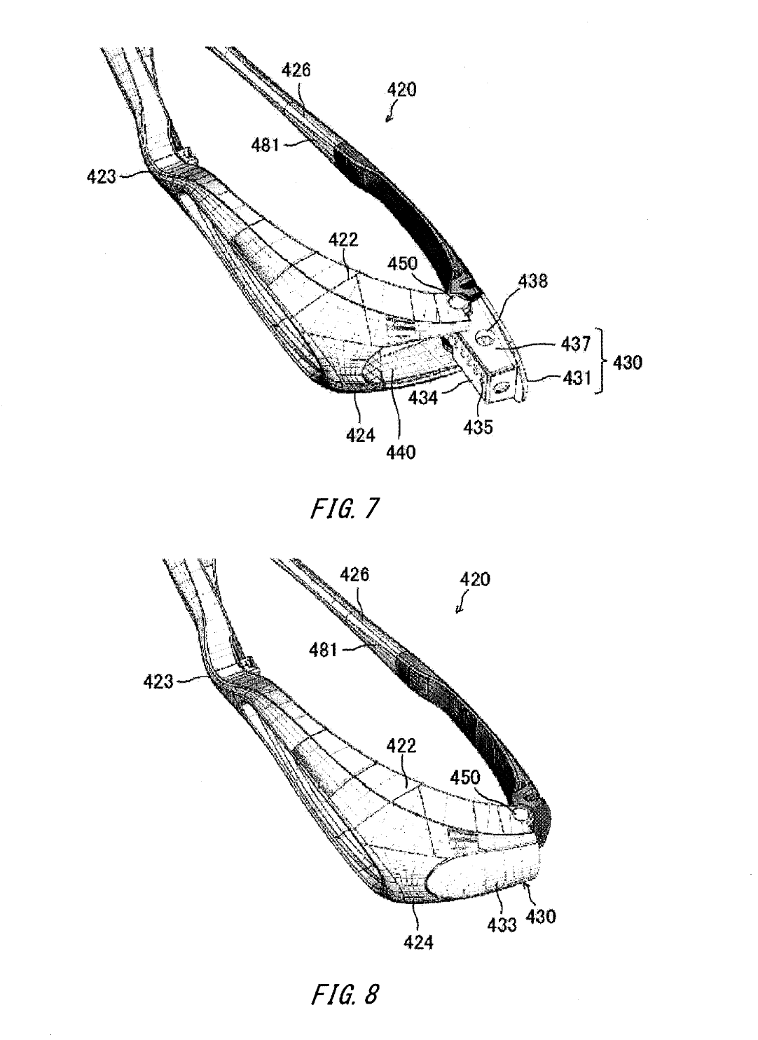

FIG. 7 through FIG. 11 schematically show the frame 420 and the liquid container 430 in another embodiment of the glasses 100. FIG. 7 through FIG. 11 mainly show the area including the left-eye side portion of the glasses. The frame 420 corresponds to the frame 120, and the liquid container 430 corresponds to the liquid container 130. Among the configurations related to the frame 420 and the liquid container 430, the configurations different from those related to the frame 120 and the liquid container 130 described above are mainly explained below, and occasionally the configurations similar to the configurations of the frame 120 and the liquid container 130 may be omitted below.

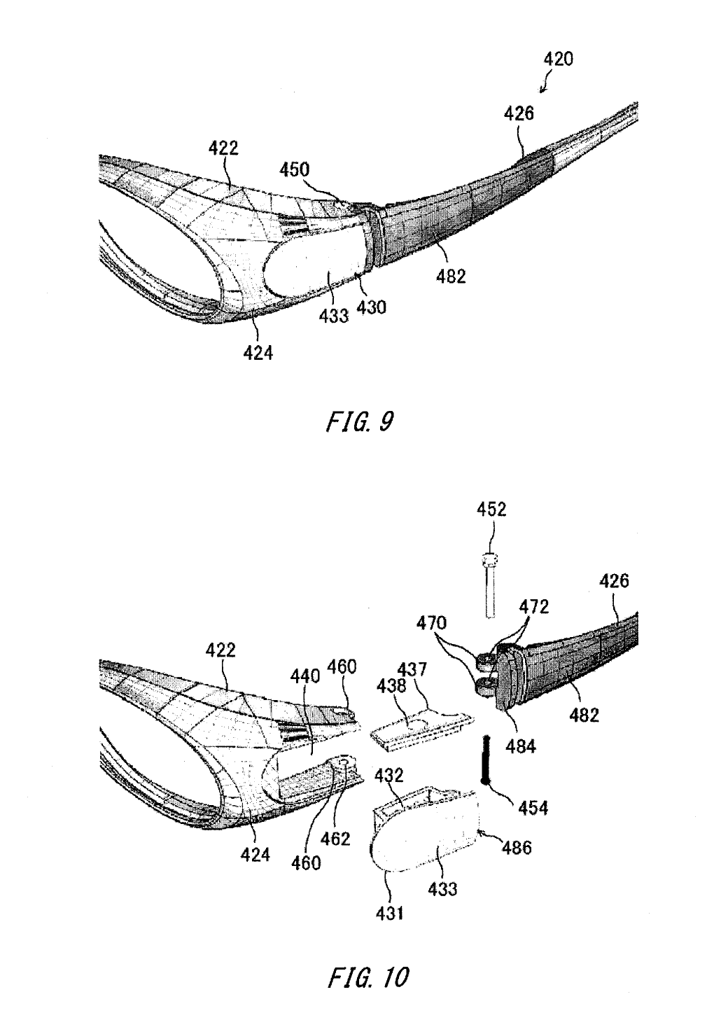

FIG. 7 schematically shows a state in which the liquid container 430 is not housed in the frame 420. FIG. 8 and FIG. 9 schematically show a state in which the liquid container 430 is housed in the frame 420. FIG. 8 schematically shows a folded state of the frame 420. FIG. 9 schematically shows the frame 420 in an unfolded state. FIG. 10 schematically shows a perspective development view of the frame 420 and the liquid container 430. FIG. 11 schematically shows a state in which the liquid container 430 is removed from the frame 420, and the lid 437 is removed from the container main body 431. As shown in FIG. 11, the liquid container 430 is provided to the frame 420 to be removable, unlike the liquid container 130.

The liquid container 430 is an example of the liquid retainer retaining a liquid. A part of the frame 420 is provided with an opening 440. At least one part of the liquid container 430 can be housed in the opening 440. The opening 440 is an example of the housing that houses at least a part of the liquid container 430. As described in more detail below, the liquid container 430 is supported, by means of a hinge, by the frame 420 to be movable between the position at which the liquid container 430 is housed in the opening 440 and the position at which the liquid container 430 is not housed in the opening 440.

In the liquid container 430, a plurality of air holes 435 are formed corresponding to the air holes 135, on the side surface 434 that would oppose to the face when the frame 420 is worn on the face of a wearer with the liquid container 430 being housed in the opening 440. The air holes 435 penetrate up to the cavity 432 of the container main body 431, and permit gaseous body to pass but do not permit a liquid to pass. The liquid retained in the liquid container 430 is vaporized to go to the face of the wearer via the air holes 435.

The frame 420 includes a rim 422 corresponding to the rim 122, a bridge 423 corresponding to the bridge 123, an end piece portion 424 corresponding to the end piece portion 124, a hinge spindle member 450 corresponding to the hinge spindle member 150, and a temple 426 corresponding to the temple 126. The frame 420 further includes a nose pad corresponding to the nose pad 121 and an ear band corresponding to an ear band 128. The bridge 423 is positioned between a pair of rims 422.

The rim 422 includes a hood member elongating in the direction of a wearer from around the lens. Accordingly, the gaseous body vaporized from the liquid container 430 is restrained from dispersing. The end piece portion 424 is provided at the edge of the rim 422, and is coupled with the temple 426 via the hinge spindle member 450. The pair of temples 426 sandwich the head of the wearer.

The liquid container 430 includes a container main body 431 corresponding to the container main body 131, and a lid 437 corresponding to the lid 137.

A cavity 432 for retaining a liquid is formed inside the liquid container 430. The cavity 432 corresponds to the cavity 132. The cavity 432 can accumulate a liquid. An example of the liquid retained in the cavity 432 is water. The inside of the cavity 432 may be processed to be water repellent. The inside of the cavity 432 may be antimicrobial-impregnated.

An opening for supplying a liquid in the cavity 432 is formed through the liquid container 430, in the state in which the liquid container 430 is not housed in the opening 440. The opening is formed in a position facing the inner surface of the opening 440 when the liquid container 430 is housed in the opening 440. Specifically, the opening is formed on the upper portion of the liquid container 430.

The lid 437 seals the upper opening of the liquid container 430. An insertion opening 438, corresponding to the insertion opening 138, is formed through the lid 437. The insertion opening 438 is an example of a liquid supply port penetrating from outside to the cavity 432. A liquid injection tool such as a dropper can be inserted through the insertion opening 438. The liquid injection tool can be inserted through the insertion opening 438 when the liquid container 430 is not housed in the opening 440, to supply a liquid from the liquid injection tool to the cavity 432. For example, the insertion opening 438 has a circular sectional shape having a diameter of 3.5 mm. The sectional diameter of the insertion opening 438 may be equal to or above 1 mm and equal to or below 7 mm. Preferably, the sectional diameter of the insertion opening 438 may be equal to or above 2 mm and equal to or below 5 mm.

The lid 437 may be formed by soft resin. The lid 437 may be formed by a material having elasticity higher than the elasticity of the material forming the container main body 431. The material of the lid 437 may be elastomer such as crude rubber, synthetic rubber, silicone rubber, or the like. In this case, when the liquid container 430 is housed in the opening 440 of the frame 420, the lid 437 provided between the inner surface of the opening 440 and the liquid container 430 will press them, to make it hard to remove the liquid container 430 from the opening 440.

The lid 437 may be provided to be removable with respect to the upper opening of the liquid container 430. A user can remove the lid 437 from the upper opening of the liquid container 430 when the liquid container 430 is not housed in the opening 440. Because the lid 437 can be removed to expose the upper opening of the liquid container 430, a liquid can be supplied through the exposed opening to the cavity 432 without using any liquid injection tool. In addition, the liquid retained in the cavity 432 can be discharged to outside from the cavity 432 through the exposed upper opening. Therefore, the liquid retained in the cavity 432 can be easily exchanged.

The liquid container 430 is linked to the frame 420 by means of the hinge spindle member 450. Specifically, the liquid container 430 is linked to the end piece portion 424 by means of the hinge spindle member 450. More specifically, the liquid container 430 is supported to be movable with respect to the end piece portion 424, by means of the hinge spindle member 450. The container main body 431 of the liquid container 430 includes an insertion member 436 to which the hinge spindle member 450 is inserted. The hinge spindle member 450 is inserted to the insertion opening 474 of the insertion member 436 of the liquid container 430. The insertion member 436 corresponds to the insertion member 136, and the insertion opening 474 corresponds to the insertion opening 174.

The insertion opening 474 retains the hinge spindle member 450 to be rotatable. The insertion member 436 includes a slit portion 510 along the rotation axis of the hinge spindle member 450. The slit portion 510 provides a link portion linking between the insertion opening 474 and the outside of the insertion member 436. On the sectional surface orthogonal to the rotation axis of the hinge spindle member 450, the inner periphery of the insertion opening 474 is distanced by a portion provided with the slit portion 510.

On the sectional surface orthogonal to the rotation axis of the hinge spindle member 450, the diameter of the insertion opening 474 is larger than the diameter of the hinge spindle member 450. On the sectional surface orthogonal to the rotation axis of the hinge spindle member 450, the width of the slit portion 510 is smaller than the diameter of the hinge spindle member 450.

When removing the liquid container 430 from the frame 420, in the state in which the liquid container 430 is mounted to the frame 420, when the hinge spindle member 450 of the insertion opening 474 exerts force in the direction towards the slit portion 510, onto the liquid container 430, while the liquid container 430 is open, the slit portion 510 is pressed by the hinge spindle member 450 to be elastically pressed and extended. The hinge spindle member 450 goes through the extended slit portion 510, to be removed from the insertion member 436. When the hinge spindle member 450 is removed from the insertion member 436, the slit portion 510 returns elastically to its original position.

When mounting the liquid container 430 to the frame 420 from the state in which the liquid container 430 is removed from the frame 420, the slit portion 510 is caused to abut against the hinge spindle member 450, and as a result of the hinge spindle member 450 applying a force in the direction towards the insertion opening 474, on the liquid container 430, the slit portion 510 is pressed by the hinge spindle member 450 to be elastically extended. The hinge spindle member 450 goes through the extended slit portion 510, to be inserted in the insertion opening 474. Then, when the hinge spindle member 450 has been in the insertion opening 474, the slit portion 510 elastically returns to its original position. Accordingly, the hinge spindle member 450 fits the insertion opening 474 to be rotatable.

When the liquid container 430 is mounted to the frame 420, the liquid container 430 rotates around the hinge spindle member 450, while inner periphery of the insertion opening 474 is in contact with the outer surface of the hinge spindle member 450, in the state in which the hinge spindle member 450 fits the insertion opening 474 to be rotatable. Therefore, to open/close the liquid container 430, the hinge spindle member 450 is not easily removed from the slit portion 510, to facilitate smooth opening/closing.

In this way, the liquid container 430 is removably mounted to the frame 420. For this reason, the liquid container 430 can be exchanged with a new liquid container. In addition, after the liquid container 430 is removed from the frame 420 and cleaned, the liquid container 430 can be mounted to the frame 420 again. Therefore, the glasses can be used hygienically.

An insertion member 460 is formed on the rim 422, through which the hinge spindle member 450 is inserted. The hinge spindle member 450 is inserted to the insertion opening 462 of the insertion member 460. The insertion member 460 corresponds to the insertion member 160. The insertion opening 462 corresponds to the insertion opening 162.

An insertion member 470 is formed on the temple 426, through which the hinge spindle member 450 is inserted. The hinge spindle member 450 is inserted to the insertion opening 472 of the insertion member 470. The insertion member 470 corresponds to the insertion member 170. The insertion opening 472 corresponds to the insertion opening 172.

In this way, the hinge spindle member 450 is inserted to the insertion opening 462, the insertion opening 472, and the insertion opening 474. The hinge spindle member 450 includes a shaft member 452 inserted from the upper insertion member 460 and a shaft member 454 inserted from the lower insertion member 460. The shaft member 452 corresponds to the shaft member 152, and the shaft member 454 corresponds to the shaft member 154.

The shaft member 454 and the shaft member 452 include an insertion member to insert to each insertion opening and a head portion larger than the insertion opening 462. The shaft member 454 is assembled so that at least a part of the insertion member of the shaft member 454 is housed in the insertion member of the shaft member 452. The insertion member of the shaft member 452 is inserted to the respective insertion opening, to be assembled to the end piece portion 424 as a hinge spindle member 450 together with the shaft member 454.

The hinge spindle member 450 and the insertion member 436 provide a hinge mechanism movably supporting the liquid container 430 with respect to the frame 420. This hinge mechanism enables the liquid container 430 to be movably supported with respect to both the end piece portion 424 and the temple 426. Specifically, the liquid container 430 rotates independently around the hinge spindle member 450, with respect to the temple 426 and the end piece portion 424. Therefore, the liquid container 430 can rotate around the hinge spindle member 450, and can more between the position at which it is housed in the opening 440 and the position at which it is not housed in the opening 440. In this way, the hinge mechanism supports the liquid container 430 to the frame 420 to be movable between the position at which the liquid container 430 is housed in the opening 440 and the position at which the liquid container 430 is not housed in the opening 440. Therefore, the liquid container 430 can be supported to the frame in such a manner as to facilitate injection or exchange of liquid retained in the liquid container 430. In addition, the liquid container 430 is hard to be removed from the frame 420, and the possibility of losing the liquid container 430 can be reduced.

The hinge spindle member 450 and the insertion member 470 provide a hinge mechanism supporting the temple 426 to the end piece portion 424 movably. This hinge mechanism supports the temple 426 movably to the end piece portion 424, between the state in which the temple 426 is folded with respect to the end piece portion 424 as shown in FIG. 7, FIG. 8, and FIG. 11, and the state in which the temple 426 is not folded with respect to the end piece portion 424 as illustrated in FIG. 9.

In this way, the opening 440 is formed on the end piece portion 424 of the frame 420, and the temple 426 is supported movably with respect to the end piece portion 424 via the hinge. The liquid container 430 and the temple 426 are rotatably supported by the hinge around the common hinge spindle member 450. Consequently, the spindle of the hinge can be shared, to be able to reduce the number of parts compared to the case in which the spindle of the hinge is not shared. It is possible to make a smaller hinge mechanism compared to the case in which the spindle of the hinge is not shared, as well as maintaining a space retaining the liquid wider.

The above-explained hinge mechanism enables the liquid container 430 and the temple 426 to independently rotate around the hinge spindle member 450. For example, it is possible to fold the temple 426 with respect to the end piece portion 424, while the liquid container 430 is housed in the opening 440. Even by folding the temple 426 with respect to the end piece portion 424, the liquid container 430 does not easily move with respect to the end piece portion 424. By rotating the liquid container 430 around the hinge spindle member 450 while the temple 426 is folded with respect to the end piece portion 424, it is possible to remove out the liquid container 430 from the opening 440.

If the temple 426 is not folded with respect to the end piece portion 424, the end-piece-portion-side side surface 484 of the temple 426 abuts against the temple-side side surface 486 of the container main body 431 of the liquid container 430. Therefore, if the temple 426 is not folded with respect to the end piece portion 424, the liquid container 430 will not be easily removed from the opening 440. Therefore, when the glasses are worn by a wearer, the liquid container 430 will not be easily removed from the opening 440.

When the liquid container 430 is housed in the opening 440, the liquid container 430 has a side surface 434 and a side surface 433 provided outside and opposite to the side surface 434, where the side surface 434 will be provided to face the face when the frame 420 provided with the liquid container 430 is worn on the face. The side surface 434 and the side surface 433 may have a form conforming to the side surface of the frame 420. For example, the side surface 434 and the side surface 433 may have a form conforming to the side surface of the end piece portion 424. The side surface 433 may have a form conforming to the outer surface 482 of the temple 426. The side surface 434 may have a form conforming to the inner surface 481 which is a surface opposite to the outer surface 482 in the temple 426. The side surface 434 and the side surface 433 may be provided in the frame 420 more inner than the corresponding side surface of the frame 420. The side surface 433 has a form conforming to the outer side surface of the end piece portion 424, and the side surface 434 may be provided inner than the inner side surface of the end piece portion 424.

The air holes 435 are provided in matrix formation of 2 rows and 5 columns on the side surface 434. The air hole 435 is an example of the gaseous body transmission member causing a gaseous body to pass from the cavity 432 to the face, when the liquid container 430 is housed in the opening 440 and the frame 420 is mounted on the face. Specifically, the air hole 435 does not cause a liquid to pass from the cavity 432 to the side surface 434, but cause a gaseous body to pass. In an example, a section form of the air hole 435 parallel to the side surface 434 is circular having a diameter of 1 mm.

Accordingly, a liquid is restrained from being leaked from the air hole 435. For example, a liquid leaking from the air hole 435 is restrained even if the air hole 435 is not covered with water retentive or water absorbing materials such as felt, paper, sea sponge, sponge, water absorptive polymer, and hydrogel, or if the cavity 432 is not covered with a filler material made of water retentive or water absorbing materials. Therefore, it becomes possible to accumulate a liquid inside the liquid container 430 without using any filler material. Consequently, compared to a case in which the entire inside of the liquid container 430 is filled with a filler material, more liquid in quantity can be accumulated. Furthermore, even in a case in which the liquid container 430 is not filled with any filler material, a liquid leak from the air hole 435 can be restrained, thereby enabling to use the glasses hygienically.

The liquid container 430 may not have any lid 437. When the liquid container 430 is housed in the opening 440, even without the lid 437, the liquid retained in the cavity 432 can be restrained from leaking outside, if the opening of the cavity 432 can be substantially sealed with the inside of the opening 440.

The sectional form of the insertion opening 438 may be non-circular. For example, as a modification example of the liquid container 430, the configuration similar to the configuration regarding the liquid container 130 explained with reference to FIG. 5 can be adopted.

A slit linking to the insertion opening 438 may be provided through the lid 437. For example, as a modification example of the liquid container 430, the configuration similar to the configuration regarding the liquid container 130 explained with reference to FIG. 6 can be adopted.

A case in which the sectional form of the air hole 435 is circular was explained regarding the liquid container 430, the liquid container 230, and the liquid container 330. In addition, a case in which the plurality of air holes 435 are aligned in a matrix formation was explained. However, the form, number, and positioning of the air holes 435 are not limited as explained above. For example, there may be a single air hole 435. In other words, there may be one or more air holes 435. When a plurality of air holes 435 are provided, the plurality of air holes 435 may not be aligned. The form of the air holes 435, as well as the number and positioning thereof may be determined to cause a gaseous body to pass from the cavity 432 to the side surface 434, but not to cause a liquid to pass through.

The form of the air hole 435 may be determined so as to enable water vapor to pass from the cavity 432 to the inner surface of the frame 420, but not to cause any pure water or tap water to pass through. The form of the air hole 435 may be the sectional form of the air hole 435, the size of the section, and the distance for the air hole 435 from the surface towards the cavity 432 to the inner surface of the frame 420, for example. Water-vapor transmission ratio testing method determined by JIS Z0208 (Cup method) and water-vapor transmission ratio testing method determined by JIS K7129 (Lyssy method) may be used to determine whether water vapor transmits through the air hole 435, by measuring the amount of water vapor passing through the test piece piece. Determination that water vapor passes through the air hole 435 may be done when the water vapor transmission amount when the test piece is provided with the air hole 435 is more than the water vapor transmission amount when the test piece is not provided with the air hole 435.

Determination on whether pure water or tap water transmits through the air hole 435 may be made by determining whether pure water or tap water passes through the air hole 435 when left still for 10 minutes in the state in which the pressure difference of 9.806 Pa or below is caused between the opening of the air hole 435 towards the cavity 432 and the opening of the air hole 435 towards the inner surface of the frame 420. Whether pure water or tap water has passed through the air hole 435 can be determined by confirming leakage of water in liquid form by visual observation. Preferably, the pressure difference may be greater than 9.806 Pa and equal to or below 49.03 Pa, and more preferably, the pressure difference may be greater than 49.03 Pa and equal to or below 98.06 Pa. Still more preferably, the pressure difference may be greater than 98.06 Pa and equal to or below 294.18 Pa.

When the sectional form of the air hole 435 is circular, the diameter of the air hole 435 may be equal to or above 0.1 mm and equal to or below 1.5 mm, preferably equal to or above 0.3 mm and equal to or below 1.2 mm, and more preferably equal to or above 0.5 mm and equal to or below 1 mm. When the sectional form of the air hole 435 is ellipsoidal, the major axis of the air hole 435 may be equal to or above 0.1 mm and equal to or below 1.7 mm, preferably equal to or above 0.5 mm and equal to or below 1.4 mm, more preferably equal to or above 0.7 mm and equal to or below 1.2 mm. For the air hole 435, the distance from the surface towards the cavity 432 to the inside surface of the frame 420 may be equal to or above 0.1 mm and equal to or below 1.5 mm, preferably equal to or above 0.3 mm and equal to or below 1.2 mm, more preferably equal to or above 0.5 mm and equal to or below 1 mm.

The summation of the volumes of the plurality of air holes 435 may be smaller than the volume of the cavity 432. Here, when the filler material is provided inside the cavity 432, the volume of the portion of the inside of the cavity 432 occupied by the filler material is not included in the volume of the cavity 432.

The air hole 435 may be provided above the position corresponding to the water surface when the frame 420 provided with the liquid container 430 is worn on the face. Note that when the size of the air hole 435 is sufficiently small, the air hole 435 may be provided below the position corresponding to the water surface when the frame 420 provided with the liquid container 430 is worn on the face.

According to the above-explained configuration, the gaseous body generated by vaporization of the liquid accumulated in the cavity 432 passes through the air hole 435 to be supplied towards the inner side of the frame 420. In addition, since the air hole 435 does not pass through the liquid accumulated in the cavity 432, scattering of the liquid onto the face of the wearer can be restrained.

In the present embodiment, the air hole 435 is explained to be a gaseous body transmission member. However, the gaseous body transmission member is not limited to this. The gaseous body transmission member may include an organic polymer film or an inorganic porous film causing a gaseous body to permeate but not a liquid. The gaseous body transmission member may include an organic polymer film or an inorganic porous film causing a water vapor to permeate but not pure water or tap water. The gaseous body transmission member may be a silicone rubber. According to this configuration, liquid leak from the air hole 435 can also be restrained. For example, even when the air hole 435 is not covered with water retentive or water absorbing materials, liquid leak from the air hole 435 can be restrained. In this case, more liquid in amount can be accumulated. It is also possible to use the glasses hygienically.

An example in which the liquid container 430 is not provided with water retentive or water absorbing materials inside the cavity 432 has been explained. However, the liquid container 430 is not limited to this. Water retentive or water absorbing materials such as felt, paper, sea sponge, sponge, water absorptive polymer, and hydrogel may configure a part of the gaseous body transmission member. There may be water retentive or water absorbing materials provided in the cavity 432. Accordingly, even when the size of the air hole 435 is large, liquid leak from the cavity 432 can be restrained. Note that in this case, the upper edge of the water retentive or water absorbing materials is preferably above the liquid surface of the liquid accumulated in the cavity.

When water retentive or water absorbing materials are provided inside the cavity 432, the volume of the inside of the cavity 432 occupied by the water retentive or water absorbing materials may be smaller than half the volume of the cavity 432 in the state in which there is no water retentive or water absorbing material provided in the cavity 432. By doing so, more liquid in amount can be accumulated in the cavity 432.

An example in which the liquid container 430 is open/close from the outer surface of the frame 420, and the liquid container 430 moves between the position at which the liquid container 430 is housed in the opening 440 and the position at which the liquid container 430 is not housed in the opening 440 was explained as a configuration to open/close the liquid container 430. However, the direction in which the liquid container 430 is open/close is not limited to this. For example, the liquid container 430 may be open/close from the inner surface. The liquid container 430 may further be open/close from both of the outer surface and the inner surface.

An example in which the liquid container 430 is housed in the opening 440 of the frame 420 was explained as a configuration to house the liquid container 430. However, the housing that houses therein the liquid container 430 is not limited to this. For example, the liquid container 430 may be housed in the concave portion formed for the frame 420. For example, the concave portion may be formed on the inner surface or the outer surface of the frame 420, to house the liquid container 430 in the concave portion. For example, the concave portion housing the liquid container 430 may be provided on the inner surface of the frame 420. In this case, the liquid container 430 may be open/close from the inner surface of the frame 420. The concave portion housing therein the liquid container 430 may be formed on the outer surface of the frame 420. In this case, the liquid container 430 may be open/close from the outer surface of the frame 420.

An example in which the housing that houses the liquid container 430 is provided in the end piece portion 424 in the liquid container 430 was explained. However, the position of the housing is not limited to this. The housing may be formed in the temple.

An example in which the spindle supporting movably the liquid container 430 with respect to the frame 420 is also used as the spindle supporting movably the temple 426 with respect to the end piece portion 424 in the liquid container 430 was explained. However, the mechanism for supporting the liquid container 430 movably to the frame 420 is not limited to this. The liquid container 430 may be supported movably to the frame 420 by the spindle different from the spindle movably supporting the temple 426 with respect to the end piece portion 424. For example, the frame 420 may include a hinge for movably supporting the liquid container 430 to the frame 420 and a hinge for movably supporting the temple 426 to the end piece portion 424. In addition, the liquid container 430 may be supported movably with respect to the frame 420 by means of a displacement mechanism other than the hinge mechanism.

In the above-described embodiment, the container main body 131 and the container main body 431 may be an elastic member formed by an elastic material such as an elastic resin. For example, the container main body 131 and the container main body 431 are formed by polyamide resin. Specifically, the container main body 131 and the container main body 431 may be formed by grilamid (registered trademark) TR-90. The container main body 131 and the container main body 431 may be a hard member formed by a hard material such as a hard resin. The lid 137 may be formed by a material that is the same as the material forming the container main body 131. The lid 437 may be formed by a material that is the same as the material forming the container main body 431.

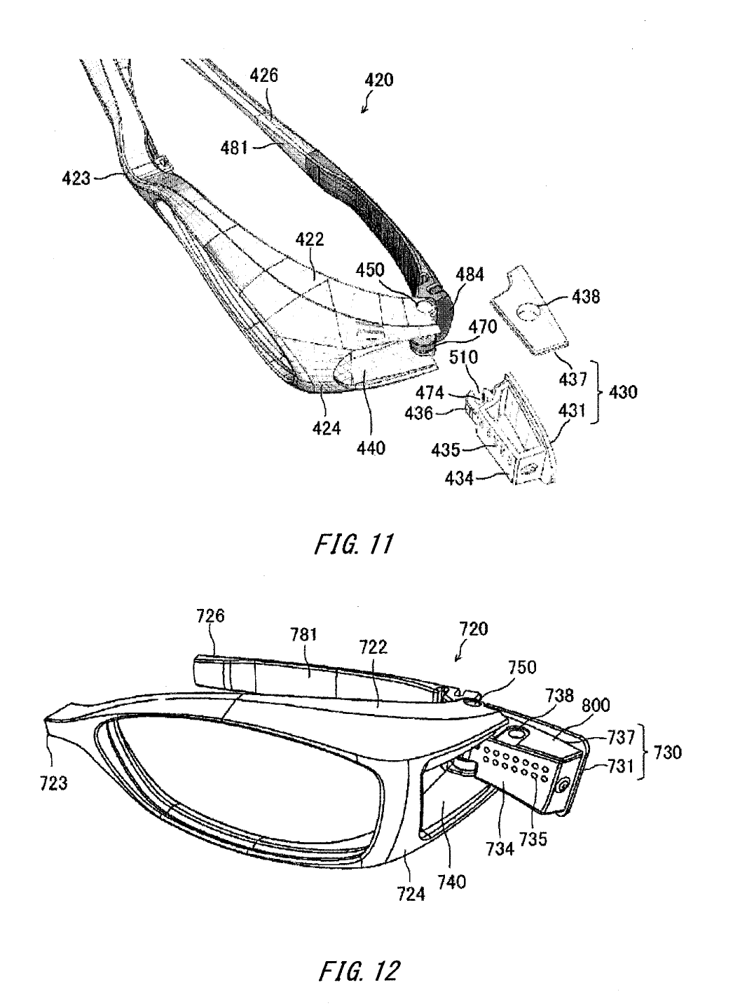

FIG. 12 through FIG. 15 schematically show a frame 720 and a liquid container 730 according to another embodiment of the glasses 100. FIG. 12 through FIG. 15 mainly show the area including the left-eye side portion of the glasses. The frame 720 corresponds to the frame 420, and the liquid container 730 corresponds to the liquid container 430. The container main body 731 of the liquid container 730 corresponds to the container main body 431 of the liquid container 430. The lid 737 of the liquid container 730 corresponds to the lid 437 of the liquid container 430.

The frame 720 includes a liquid container 730 different from the liquid container 430 of the frame 420. For example, the lid 737 of the liquid container 730 is different from the lid 437 of the frame 420. At least in this point, the frame 720 is different from the frame 420. The other constituting elements of the frame 720 may have a configuration similar to that of the corresponding constituting elements of the frame 420.

Among the configurations related to the frame 720 and the liquid container 730, the configurations different from those related to the frame 420 and the liquid container 430 described above are mainly explained below, and occasionally the configurations similar to the configurations of the frame 420 and the liquid container 430 may be omitted below.

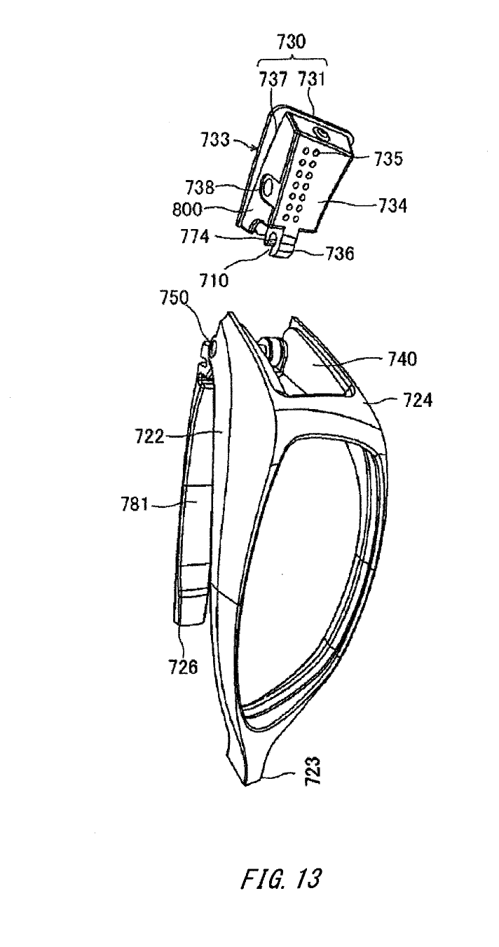

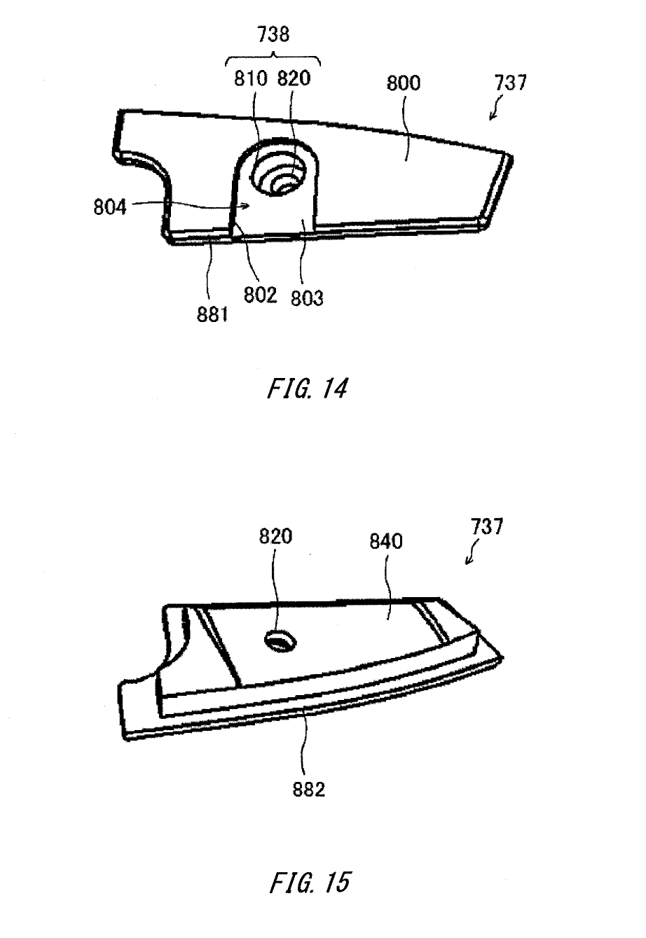

FIG. 12 schematically shows a state in which the liquid container 730 is not housed in the frame 720. FIG. 12 schematically shows a folded state of the frame 720. FIG. 13 schematically shows a state in which the liquid container 730 is removed from the frame 720. FIG. 14 and FIG. 15 shows perspective views of the lid 737.

The liquid container 730 is an example of a liquid retainer for retaining a liquid. The opening 740 is formed on a part of the frame 720, and at least a part of the liquid container 730 may be housed in the opening 740. The opening 740 is an example of a housing in which at least a part of the liquid container 730 is housed. Just as the liquid container 430, the liquid container 730 is supported by the frame 720 via a hinge, to be movable between a position in which the liquid container 730 is housed in the opening 740 and the liquid container 730 is not housed in the opening 740.

In the liquid container 730, a plurality of air holes 735 are formed corresponding to the air holes 435, on the side surface 734 that would oppose to the face when the frame 720 is worn on the face of a wearer and the liquid container 730 is housed in the opening 740. The air holes 735 penetrate up to the cavity in the container main body 731, and permit gaseous body to pass but do not permit a liquid to pass. The liquid retained in the liquid container 730 is vaporized to go to the face of the wearer via the air holes 735.

The frame 720 includes a rim 722 corresponding to the rim 422, a bridge 723 corresponding to the bridge 423, an end piece portion 724 corresponding to the end piece portion 424, a hinge spindle member 750 corresponding to the hinge spindle member 450, and a temple 726 corresponding to the temple 426. The frame 720 includes a nose pad similar to the nose pad of the frame 420. The frame 720 further includes an ear band similar to the ear band of the frame 420. The bridge 723 is positioned between a pair of rims 722.

The rim 722 includes a hood member elongating in the direction of a wearer from around the lens. Accordingly, the gaseous body vaporized from the liquid container 730 is restrained from dispersing. The end piece portion 724 is provided at the edge of the rim 722, and is coupled with the temple 726 via the hinge spindle member 750. The pair of temples 726 sandwich the head of the wearer.

The liquid container 730 includes a container main body 731 and a lid 737. Just as the container main body 431, the container main body 731 may be an elastic member formed by an elastic material such as an elastic resin. For example, the container main body 731 is formed by polyamide resin. Specifically, the container main body 731 may be formed by grilamid (registered trademark) TR-90. The container main body 731 may be a hard member formed by a hard material such as a hard resin.

A cavity for retaining a liquid is formed inside the liquid container 730, the cavity corresponding to the cavity 432 of the liquid container 430. In the present embodiment, “cavity of the liquid container 730” means a cavity corresponding to the cavity 432 of the liquid container 430. Just as the cavity 432 of the liquid container 430, the cavity of the liquid container 730 can accumulate a liquid. An example of the liquid retained in the cavity of the liquid container 730 is water. The inside of the cavity of the liquid container 730 may be processed to be water repellent. The inside of the cavity of the liquid container 730 may be antimicrobial-impregnated.

Just as in the case of the liquid container 430, an opening for supplying a liquid to the cavity of the liquid container 730 is formed through the liquid container 730, in the state in which the liquid container 730 is not housed in the opening 740. The opening is formed in a position facing the inner surface of the opening 740 when the liquid container 730 is housed in the opening 740. Specifically, the opening is formed on the upper portion of the liquid container 730. Note that this opening is occasionally referred to as “upper opening” of the liquid container 730.

The lid 737 seals the upper opening of the liquid container 730. An insertion opening 738 is formed through the lid 737. The insertion opening 738 is an example of a liquid supply port penetrating from outside to the cavity of the liquid container 730. A liquid injection tool such as a dropper can be inserted through the insertion opening 738. The liquid injection tool can be inserted through the insertion opening 738 when the liquid container 730 is not housed in the opening 740, to supply a liquid from the liquid injection tool to the cavity of the liquid container 730.

The lid 737 may be formed by a material having rubber elasticity. The lid 737 may be formed by elastomer such as rubber, for example. The material of the lid 737 may be crude rubber, synthetic rubber, silicone rubber, or the like. When the liquid container 730 is housed in the opening 740 of the frame 720, the lid 737 provided between the inner surface of the opening 740 and the liquid container 730 will press them, to make it hard to remove the liquid container 730 from the opening 740. In addition, since the inner surface of the opening 740 and the upper surface 800 of the lid 737 are in close contact to each other, the liquid contained in the cavity of the liquid container 730 can be restrained from leaking outside of the liquid container 730 from the gap of the lid 737.

The lid 737 may be provided to be removable with respect to upper opening of the liquid container 730. A user can remove the lid 737 from the upper opening of the liquid container 730 when the liquid container 730 is not housed in the opening 740. Because the lid 737 can be removed to expose the upper opening of the liquid container 730, a liquid can be supplied through the exposed opening to the cavity of the liquid container 730 without using any liquid injection tool. In addition, the liquid retained in the cavity of the liquid container 730 can be discharged to outside from the cavity of the liquid container 730, via the exposed upper opening. Therefore, the liquid retained in the cavity of the liquid container 730 can be easily exchanged.

The liquid container 730 is linked to the frame 720 by means of the hinge spindle member 750. Specifically, the liquid container 730 is linked to the end piece portion 724 by means of the hinge spindle member 750. More specifically, the liquid container 730 is supported to be movable with respect to the end piece portion 724, by means of the hinge spindle member 750. The container main body 731 of the liquid container 730 includes an insertion member 736 to which the hinge spindle member 750 is inserted. The hinge spindle member 750 is inserted to the insertion opening 774 of the insertion member 736 of the liquid container 730. The insertion member 736 corresponds to the insertion member 436, and the insertion opening 774 corresponds to the insertion opening 474.

The insertion opening 774 retains the hinge spindle member 750 to be rotatable. The insertion member 736 includes a slit portion 710 along the rotation axis of the hinge spindle member 750. The slit portion 710 provides a link portion linking between the insertion opening 774 and the outside of the insertion member 736. On the sectional surface orthogonal to the rotation axis of the hinge spindle member 750, the inner periphery of the insertion opening 774 is distanced by a portion provided with the slit portion 710.

On the sectional surface orthogonal to the rotation axis of the hinge spindle member 750, the diameter of the insertion opening 774 is larger than the diameter of the hinge spindle member 750. On the sectional surface orthogonal to the rotation axis of the hinge spindle member 750, the width of the slit portion 710 is smaller than the diameter of the hinge spindle member 750.

When removing the liquid container 730 from the frame 720, in the state in which the liquid container 730 is mounted to the frame 720, when the hinge spindle member 750 in the insertion opening 774 exerts force in the direction towards the slit portion 710, onto the liquid container 730, when the liquid container 730 is open, the slit portion 710 is pressed by the hinge spindle member 750 to be elastically pressed and extended. The hinge spindle member 750 goes through the extended slit portion 710, to be removed from the insertion member 736. When the hinge spindle member 750 is removed from the insertion member 736, the slit portion 710 returns elastically to its original position.

When mounting the liquid container 730 to the frame 720 from the state in which the liquid container 730 is removed from the frame 720, the slit portion 710 is caused to abut against the hinge spindle member 750, and as a result of the hinge spindle member 750 applying a force in the direction towards the insertion opening 774, on the liquid container 730, the slit portion 710 is pressed by the hinge spindle member 750 to be elastically extended. The hinge spindle member 750 goes through the extended slit portion 710, to be inserted in the insertion opening 774. Then, when the hinge spindle member 750 has been in the insertion opening 774, the slit portion 710 elastically returns to its original position. Accordingly, the hinge spindle member 750 fits the insertion opening 774 to be rotatable.

When the liquid container 730 is mounted to the frame 720, the liquid container 730 rotates around the hinge spindle member 750, while inner periphery of the insertion opening 774 is in contact with the outer surface of the hinge spindle member 750, in the state in which the hinge spindle member 750 fits the insertion opening 774 to be rotatable. Therefore, to open/close the liquid container 730, the hinge spindle member 750 is not easily removed from the slit portion 710, to facilitate smooth opening/closing.

In this way, the liquid container 730 is removably mounted to the frame 720. For this reason, the liquid container 730 can be exchanged with a new liquid container. In addition, after the liquid container 730 is removed from the frame 720 and cleaned, the liquid container 730 can be mounted to the frame 720 again. Therefore, the glasses can be used hygienically.

An insertion member is formed on the rim 722, through which the hinge spindle member 750 is inserted. Since the insertion member of the rim 722 corresponds to the insertion member 460 of the rim 422, and has a configuration similar to that of the insertion member 460, the explanation of the details of the insertion member of the rim 722 will be omitted below. An insertion member is provided to the temple 726, through which the hinge spindle member 750 is inserted. The insertion member of the temple 726 corresponds to the insertion member 470 of the temple 426, and has a configuration similar to that of the insertion member 470, and so explanation of the details of the insertion member of the temple 726 is omitted below. In addition, since the hinge spindle member 750 has a shaft member similar to the shaft member 452 of the hinge spindle member 450 and a shaft member similar to the shaft member 454 of the hinge spindle member 450, and so explanation of the details of the hinge spindle member 750 will be omitted below.

The hinge spindle member 750 and the insertion member 736 provide a hinge mechanism supporting the liquid container 730 with respect to the frame 720 movably. This hinge mechanism supports, to be movable, the liquid container 730 both to the end piece portion 724 and the temple 726. Specifically, the liquid container 730 rotates independently around the hinge spindle member 750, with respect to the temple 726 and the end piece portion 724. Therefore, the liquid container 730 can rotate around the hinge spindle member 750 and can move between a position housed in the opening 740 and a position not housed in the opening 740. In this way, the hinge mechanism supports the liquid container 730 to the frame 720 to be movable between the position at which the liquid container 730 is housed in the opening 740 and the position at which the liquid container 730 is not housed in the opening 740. For this reason, the liquid container 730 can be supported to the frame in a manner in which the liquid to be retained in the liquid container 730 can be injected and exchanged easily. In addition, the liquid container 730 is hard to remove from the frame 720, which reduces a possibility of losing the liquid container 730.

The hinge spindle member 750 and the insertion member of the temple 726 provide a hinge mechanism supporting the temple 726 to the end piece portion 724 movably. This hinge mechanism enables the temple 726 to be supported movably by the end piece portion 724 between the state in which the temple 726 is folded with respect to the end piece portion 724 and the state in which the temple 726 is not folded with respect to the end piece portion 724 as illustrated in FIG. 12 and FIG. 13.

In this way, the opening 740 is formed on the end piece portion 724 of the frame 720, and the temple 726 is supported movably with respect to the end piece portion 724, via the hinge. The liquid container 730 and the temple 726 are rotatably supported by the hinge around the common hinge spindle member 750. Consequently, the spindle of the hinge can be shared, to be able to reduce the number of parts compared to the case in which the spindle of the hinge is not shared. It is possible to make a smaller hinge mechanism compared to the case in which the spindle of the hinge is not shared, as well as maintaining a space retaining the liquid wider.

The above-explained hinge mechanism enables the liquid container 730 and the temple 726 to independently rotate around the hinge spindle member 750. For example, it is possible to fold the temple 726 with respect to the end piece portion 724, while the liquid container 730 is housed in the opening 740. Even by folding the temple 726 with respect to the end piece portion 724, the liquid container 730 does not move easily with respect to the end piece portion 724. By rotating the liquid container 730 around the hinge spindle member 750 while the temple 726 is folded with respect to the end piece portion 724, it is possible to remove out the liquid container 730 from the opening 740.

When the liquid container 730 is housed in the opening 740, the liquid container 730 has a side surface 734 and a side surface 733 provided outside and opposite to the side surface 734, where the side surface 734 will be provided to face the face when the frame 720 provided with the liquid container 730 is worn on the face. The side surface 734 corresponds to the side surface 434 of the liquid container 430, and has a configuration similar to that of the side surface 434. The side surface 733 corresponds to the side surface 433 of the liquid container 430, and has a configuration similar to that of the side surface 433. Therefore, explanation of the details of the side surface 733 and the side surface 734 of the liquid container 730 is omitted below.

The air holes 735 are provided in matrix formation on the side surface 734. For example, the air holes 735 are provided in a matrix formation of 2 rows and 7 columns on the side surface 734. The air hole 735 is an example of the gaseous body transmission member causing a gaseous body to pass from the cavity of the liquid container 730 to the face, when the liquid container 730 is housed in the opening 740 and the frame 720 is mounted on the face. Specifically, the air hole 735 does not cause a liquid to pass from the cavity of the liquid container 730 to the side surface 734, but cause a gaseous body to pass. In an example, a section form of the air hole 735 parallel to the side surface 734 is circular having a diameter of 1 mm.

Accordingly, a liquid is restrained from being leaked from the air hole 735. For example, a liquid leaking from the air hole 735 is restrained even if the air hole 735 is not covered with water retentive or water absorbing materials such as felt, paper, sea sponge, sponge, water absorptive polymer, and hydrogel, or if the cavity of the liquid container 730 is not covered with a filler material made of water retentive or water absorbing materials. Therefore, it becomes possible to accumulate a liquid inside the liquid container 730 without using any filler material. Consequently, compared to a case in which the entire inside of the liquid container 730 is filled with a filler material, more liquid in quantity can be accumulated. Furthermore, even in a case in which the liquid container 730 is not filled with any filler material, a liquid leak from the air hole 735 can be restrained, thereby enabling to use the glasses hygienically.

The configuration regarding the lid 737 is explained below. The lid 737 includes an upper surface 800, a lower surface 840, a first side portion 881, and a second side portion 882. The lower surface 840 is a surface opposite to the upper surface 800. A part of the lower surface 840 defines a part of the cavity of the liquid container 730.

The first side portion 881 and the second side portion 882 define a part of the outer periphery of the lid 737. The first side portion 881 is a portion to face the face when the liquid container 730 is housed in the opening 740 and the frame 720 is mounted on the face of a wearer. The first side portion 881 includes a surface along the side surface 734. The second side portion 882 is a portion opposite to the first side portion 881.

A concave portion 804 is formed on the upper surface 800 of the lid 737. The concave portion 804 includes a side surface portion 802 and a bottom portion 803.

The insertion opening 738 is formed on the concave portion 804. Specifically, the insertion opening 738 penetrates from the bottom portion 803 of the concave portion 804 to the lower surface 840.

The insertion opening 738 includes a first opening 810 and a second opening 820. The first opening 810 is formed on the bottom portion 803 of the concave portion 804. The second opening 820 is formed on the lower surface 840, and links to the first opening 810. The center of the first opening 810 substantially matches the center of the second opening 820.

The section size of the second opening 820 is smaller than the section size of the first opening 810. Specifically, the section area of the second opening 820 is smaller than the section area of the first opening 810.

The first opening 810 has a circular form. The second opening 820 has a circular form. The diameter of the section of the second opening 820 is smaller than the diameter of the section of the first opening 810. For example, the diameter of the section of the first opening 810 is 2.8 mm, and the diameter of the section of the second opening 820 is 1.5 mm.

The following takes an example in which the sectional form of the first opening 810 is a circle, to explain the range of the size of the section of the first opening 810. The diameter of the section of the first opening 810 is preferably equal to or above 2 mm and equal to or below 7 mm. The diameter of the section of the first opening 810 is more preferably equal to or above 2 mm and equal to or below 4 mm.

The following takes an example in which the sectional form of the second opening 820 is a circle, to explain the range of the size of the section of the second opening 820. The diameter of the section of the second opening 820 is preferably equal to or below 2.5 mm. The diameter of the section of the second opening 820 is more preferably equal to or below 2 mm. The diameter of the section of the second opening 820 may be equal to or below 1.5 mm.

Note that the section form of at least one opening from the first opening 810 and the second opening 820 may be non-circular. Even when the section form of the opening is non-circular, the area of the section of the opening preferably falls in the range of the area defined by the above-explained range of the diameter.

In this way, since the section of the first opening 810 is larger than the section of the second opening 820, it is easy to supply a liquid to a cavity of the liquid container 730 from the insertion opening 738, using a liquid injection tool or the like. Since the section of the second opening 820 is smaller than the section of the first opening 810, when a liquid is retained in the cavity of the liquid container 730, leakage of the liquid retained in the cavity of the liquid container 730 through the insertion opening 738 to outside the liquid container 730 is restrained. For example, when the liquid in the cavity of the liquid container 730 is flown out due to the liquid container 730 being shaken or the like, the liquid leakage thorough the insertion opening 738 to outside the liquid container 730 can be restrained. In addition, even when the liquid container 730 is tilted, the liquid in the cavity of the liquid container 730 is restrained from leaking through the insertion opening 738 to outside of the liquid container 730. In addition, even when the degree of adhesion between the upper surface 800 and the opening 740 becomes lower, the liquid in the cavity of the liquid container 730 is restrained from leaking through the insertion opening 738 to outside of the liquid container 730. In addition, since the section of the first opening 810 is larger than the section of the second opening 820, even when an object such as cloth, hair, or the like has contacted the vicinity of the first opening 810, the liquid retained in the cavity of the liquid container 730 is restrained from being absorbed by the object.

The concave portion 804 of the upper surface 800 elongates up to the first side portion 881. For this reason, the boundary between the first side portion 881 and the upper surface 800 has a step-wise formation conforming to the form of the concave portion 804. For this reason, the first side portion 881 includes an opening linking to the insertion opening 738, in the section along the side surface 734 of the liquid container 730. In this way, the first side portion 881 includes an opening linking to the concave portion 804. Therefore, even when the liquid container 730 is housed in the opening 740 and the upper surface 800 of the lid 737 is in close contact with the frame 720, the cavity of the liquid container 730 links to the outside of the liquid container 730 via the insertion opening 738. For this reason, the fluidity of air between the cavity of the liquid container 730 and the outside of the liquid container 730 is enhanced, thereby increasing the vaporization amount of the liquid retained in the cavity of the liquid container 730.

The height from the bottom portion 803 to the side surface portion 802 is 0.3 mm. Therefore, the concave portion 804 has a depth of 0.3 mm. Note that the height of the side surface portion 802 is preferably equal to or above 0.1 mm and equal to or below 1 mm. More preferably, the height of the side surface portion 802 is equal to or above 0.2 mm and equal to or below 0.5 mm.

As described above, the concave portion 804 of the upper surface 800 is formed to elongate up to the first side portion 881, but not up to the second side portion 882. For this reason, the leaking of the liquid retained in the cavity of the liquid container 730 is restrained from being vaporized to exit to outside from the side not opposing the wearer of the frame 720 by passing through the insertion opening 738.

As described above, the size of the section of the second opening 820 of the lid 737 is smaller than the size of the section of the first opening 810. However, the size of the section of the first opening 810 may be smaller than the size of the section of the second opening 820.

The following explains an example of respective depths of the first opening 810 and the second opening 820 when the thickness of the lid 737 from the lower surface 840 to the upper surface 800 is 3.4 mm. The boundary surface between the second opening 820 and the first opening 810 may be at the position corresponding to 1.5 mm from the lower surface 840. That is, the depth of the second opening 820 may be 1.5 mm. In addition, the boundary surface between the first opening 810 and the bottom portion 803 may be at the position corresponding to 2.9 mm from the lower surface 840. That is, the depth of the first opening 810 may be 1.4 mm.

Note that, regardless of the thickness of the lid 737 from the lower surface 840 to the upper surface 800, the value of the ratio D1/d1 between the depth d1 of the first opening 810 and the diameter D1 of the section of the first opening 810 may preferably be equal to or above 1.6 and equal to or below 2.4. The value of the ratio D1/d1 may more preferably be equal to or above 1.8 and equal to or below 2.2. In addition, the value of the ratio D2/d2 between the depth d2 of the second opening 820 and the diameter D2 of the section of the second opening 820 may preferably be equal to or above 0.8 and equal to or below 1.2. The value of the ratio D2/d2 may more preferably be equal to or above 0.9 and equal to or below 1.1.

In the embodiment described above, when the frame 120, the frame 420, and the frame 720 are collectively referred to as “frame,” the liquid container 130, the liquid container 430, and the liquid container 730 are collectively referred to as “liquid container,” the air hole 135, the air hole 435, and the air hole 735 are collectively referred to as “air hole,” the cavity 132, the cavity 432, and the cavity of the liquid container 730 are collectively referred to as “cavity,” and the side surface 134, the side surface 434, and the side surface 734 are collectively referred to as “inner side surface,” the air hole penetrates from the cavity to the inner side surface as described above. In addition, the plurality of air holes are aligned in a matrix formation. In addition, a case in which the section of the air hole is circular was mainly explained. However, the form of the air hole, the number and the position thereof are not limited to them. For example, there may be a single air hole. That is, one or more air holes may be provided. When the plurality of air holes are provided, the plurality of air holes may be aligned. The form of the air hole(s), the number and the position thereof may be determined so as to transmit gaseous body from the cavity to the inner side surface, but not to transmit any liquid.

The form of the air hole may be determined so as to enable water vapor to pass from the cavity to the inner surface of the frame, but not to cause any pure water or tap water to pass through. The form of the air hole(s) may be the sectional form of the air hole, the size of the section, and the distance for the air hole from the surface towards the cavity to the inner surface of the frame, for example. Water-vapor transmission ratio testing method determined by JIS Z0208 (Cup method) and water-vapor transmission ratio testing method determined by JIS K7129 (Lyssy method) may be used to determine whether water vapor transmits through the air hole, by measuring the amount of water vapor passing through the test piece. Determination that water vapor passes through the air hole may be done when the water vapor transmission amount when the test piece is provided with the air hole is more than the water vapor transmission amount when the test piece is not provided with the air hole.

Determination on whether pure water or tap water transmits through the air hole may be made by determining whether pure water or tap water passes through the air hole when left still for 10 minutes in the state in which the pressure difference of 9.806 Pa or below is caused between the opening of the air hole towards the cavity and the opening of the air hole towards the inner surface of the frame. Whether pure water or tap water has passed through the air hole can be determined by confirming leakage of water in liquid form by visual observation. Preferably, the pressure difference may be greater than 9.806 Pa and equal to or below 49.03 Pa, and more preferably, the pressure difference may be greater than 49.03 Pa and equal to or below 98.06 Pa. Still more preferably, the pressure difference may be greater than 98.06 Pa and equal to or below 294.18 Pa.

When the sectional form of the air hole is circular, the diameter of the air hole may be equal to or above 0.1 mm and equal to or below 1.5 mm, preferably equal to or above 0.3 mm and equal to or below 1.2 mm, and more preferably equal to or above 0.5 mm and equal to or below 1 mm. When the sectional form of the air hole is ellipsoidal, the major axis of the air hole may be equal to or above 0.1 mm and equal to or below 1.7 mm, preferably equal to or above 0.5 mm and equal to or below 1.4 mm, more preferably equal to or above 0.7 mm and equal to or below 1.2 mm. The distance from the surface towards the cavity to the inner side surface of the frame, for the air hole, may be equal to or above 0.1 mm and equal to or below 1.5 mm, preferably equal to or above 0.3 mm and equal to or below 1.2 mm, more preferably equal to or above 0.5 mm and equal to or below 1 mm.

The summation of the volumes of the plurality of air holes may be smaller than the volume of the cavity. Here, when the filler material is provided inside the cavity, the volume of the portion of the inside of the cavity occupied by the filler material is not included in the volume of the cavity.

The air hole may be provided above the position corresponding to the water surface when the frame provided with the liquid container is worn on the face. Note that when the size of the air hole is sufficiently small, the air hole may be provided below the position corresponding to the water surface when the frame provided with the liquid container is worn on the face.

According to the above-explained configuration, the gaseous body generated by vaporization of the liquid accumulated in the cavity passes through the air hole to be supplied towards the inner side of the frame. In addition, since the air hole does not pass through the liquid accumulated in the cavity, scattering of the liquid onto the face of the wearer can be restrained.

In the embodiment described above, the air hole is explained to be a gaseous body transmission member. However, the gaseous body transmission member is not limited to this. The gaseous body transmission member may include an organic polymer film or an inorganic porous film causing a gaseous body to permeate but not a liquid. The gaseous body transmission member may include an organic polymer film or an inorganic porous film causing a water vapor to permeate but not pure water or tap water. The gaseous body transmission member may be a silicone rubber. According to this configuration, liquid leak from the air hole can also be restrained. For example, even when the air hole is not covered with water retentive or water absorbing materials, liquid leak from the air hole can be restrained. In this case, more liquid in amount can be accumulated. It is also possible to use the glasses hygienically.

An example in which the liquid container is not provided with water retentive or water absorbing materials inside the cavity has been explained. However, the liquid container is not limited to this. Water retentive or water absorbing materials such as felt, paper, sea sponge, sponge, water absorptive polymer, and hydrogel may configure a part of the gaseous body transmission member. There may be water retentive or water absorbing materials provided in the cavity. Accordingly, even when the size of the air hole is large, liquid leak from the cavity can be restrained. Note that in this case, the upper edge of the water retentive or water absorbing materials is preferably above the liquid surface of the liquid accumulated in the cavity.

When water retentive or water absorbing materials are provided inside the cavity, the volume of the inside of the cavity occupied by the water retentive or water absorbing materials may be smaller than half the volume of the cavity in the state in which there is no water retentive or water absorbing material provided in the cavity. By doing so, more liquid in amount can be accumulated in the cavity.

An example in which the liquid container is open/close from the outer surface of the frame, and the liquid container moves between the position at which the liquid container is housed in the opening and the position at which the liquid container is not housed in the opening was explained as a configuration to open/close the liquid container. However, the direction in which the liquid container is open/close is not limited to this. For example, the liquid container may be open/close from the inner surface of the frame. The liquid container may further be open/close from both of the outer surface of the frame and the inner surface of the frame.

An example in which the liquid container is housed in the opening of the frame was explained as a configuration in which the liquid container is housed. However, the housing that houses therein the liquid container may not be limited to this. For example, the liquid container may be housed in the concave portion formed for the frame. For example, the concave portion may be formed on the inner surface or the outer surface the frame, to house the liquid container in the concave portion. For example, the concave portion housing the liquid container may be provided on the inner surface of the frame. In this case, the liquid container may be open/close from the inner surface of the frame. The concave portion housing therein the liquid container may be formed on the outer surface of the frame. In this case, the liquid container may be open/close from the outer surface of the frame.

When the end piece portion 124, end piece portion 424, and the end piece portion 724 are collectively referred to as “end piece portion,” and the temple 126, the temple 426, and the temple 726 are collectively referred to as “temple” in the above-described embodiments, the housing for housing the liquid container is provided in the end piece portion of the liquid container. However, the position of the housing is not limited to this. The housing may be formed on the temple.

In addition, for the liquid container 430 and the liquid container 730, a case was explained in which the spindle movably supporting the liquid container to the frame is also used as the spindle movably supporting the temple to the end piece portion. However, the mechanism for movably supporting the liquid container to the frame is not limited to this. The liquid container may be movably supported to the frame by means of a spindle different from the spindle movably supporting the temple to the end piece portion. For example, the frame may include a hinge to movably support the liquid container to the frame and a hinge to movably support the temple to the end piece portion. In addition, the liquid container may be supported movably with respect to the frame by means of a displacement mechanism other than the hinge mechanism.

In the above-explained embodiments, the eyewear was glasses. The glasses may further be used for such purposes as to correct the refractive error of the eyes of a wearer, protect the eyes of a wearer, or may be worn simply as a fashion item. However, the eyewear is not limited to glasses. The eyewear may be an equipment related to eyes, and may be face mounted equipment or head mounted equipment such as glasses, sunglasses, goggles, head mount displays, or the like. The eyewear may be a frame of the face mounted equipment or the head mounted equipment, or a part of the frame. Optical components used for eyewear may be optical components having optical characteristics matching the usage of the eyewear, not limited to the lens characteristic.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

### EXPLANATION OF REFERENCE NUMERALS

100 glasses
110 lens
120 frame
121 nose pad
122 rim
123 bridge
124 end piece portion
126 temple
128 ear band
130 liquid container
131 container main body
132 cavity
133 side surface
134 side surface
136 insertion member
135 air hole
137 lid
138 insertion opening
139 slit
140 opening
150 hinge spindle member
152 shaft member
154 shaft member
160 insertion member
162 insertion opening
170 insertion member
172 insertion opening
174 insertion opening
181 inner surface
182 outer surface
184 end-piece-portion-side side surface
186 temple-side side surface
230 liquid container
238 insertion opening
330 liquid container
420 frame
422 rim
423 bridge
424 end piece portion
426 temple
430 liquid container
431 container main body
432 cavity
433 side surface
434 side surface
435 air hole
436 link portion
437 lid
438 insertion opening
440 opening
450 hinge spindle member
452 shaft member
454 shaft member
460 insertion member
462 insertion opening
470 insertion member
472 insertion opening
474 insertion opening
481 inner surface
482 outer surface
484 end-piece-portion-side side surface
486 temple-side side surface
510 slit portion
710 slit portion
720 frame
722 rim
723 bridge
724 end piece portion
726 temple
730 liquid container
731 container main body
734 side surface
735 air hole
736 insertion member
737 lid
738 insertion opening
740 opening
750 hinge spindle member
774 insertion opening
800 upper surface
802 side surface portion
803 bottom portion
804 concave portion
810 first opening
820 second opening
840 lower surface
881 first side portion
882 second side portion

What is claimed is:

1. Eyewear comprising:
a liquid retainer including a cavity to retain a liquid; and
a frame in which a housing is formed to house at least a part of the liquid retainer, wherein
the liquid retainer is supported to the frame via a hinge, to be movable between a position at which the liquid retainer is housed in the housing and a position at which the liquid retainer is not housed in the housing, and
the liquid retainer includes a gaseous body transmission member transmitting a gaseous body from the cavity towards a face when the liquid retainer is housed in the housing and the frame is worn on the face.

2. The eyewear according to claim 1, wherein
the housing is formed on at least one of an end piece portion of the frame and a temple portion of the frame,
the temple portion is supported by the end piece portion to be movable with respect to the end piece portion, by means of the hinge, and
the liquid retainer and the temple portion are supported to be rotatable around a common spindle by the hinge.

3. The eyewear according to claim 1, wherein
the housing is formed on an end piece portion of the frame,
a temple portion of the frame is supported by the end piece portion to be movable with respect to the end piece portion, by means of the hinge, and
the liquid retainer and the temple portion are supported to be rotatable around a common spindle by the hinge.

4. The eyewear according to claim 2, wherein
the liquid retainer and the temple portion rotate around the spindle independently.

5. The eyewear according to claim 1, wherein
the liquid retainer is provided for a spindle of the hinge to be removable.

6. The eyewear according to claim 2, wherein
the hinge includes a spindle member providing the spindle, and
the temple portion couples the end piece portion to be rotatable via the spindle member.

7. The eyewear according to claim 6, wherein
the liquid retainer includes a insertion member provided with an insertion opening through which the spindle member is inserted,
the insertion member is provided with a link portion linking an inner periphery of the insertion opening and an outer periphery of the insertion opening, and
the liquid retainer is provided to the spindle member to be removable, and when removing the liquid retainer from the spindle member, the spindle member is removed from the insertion opening through the link portion.

8. The eyewear according to claim 1, wherein
the cavity accumulates therein a liquid.

9. The eyewear according to claim 1, wherein
the cavity retains a liquid in a non-absorbed state.

10. The eyewear according to claim 1, wherein
the liquid retainer is provided with one or more air holes at a surface facing a face when the liquid retainer is housed in the housing and the frame is worn on the face, the one or more air holes penetrating up to the cavity, and transmitting a gaseous body but not transmitting a liquid.

11. The eyewear according to claim 1, wherein
the liquid retainer is provided with an opening at a position facing an inner surface of the housing when the liquid retainer is housed in the housing.

12. The eyewear according to claim 1, wherein
the liquid retainer is provided with an opening to supply a liquid to the cavity in a state in which the liquid retainer is not housed in the housing, and
the opening is formed at a position facing an inner surface of the housing when the liquid retainer is housed in the housing.

13. The eyewear according to claim 11, further comprising
a lid member sealing the opening.

14. The eyewear according to claim 13, wherein
the lid member is provided for the opening to be removable.

15. The eyewear according to claim 13, wherein
the lid member is provided with a liquid supply port penetrating from outside to the cavity.

16. The eyewear according to claim 15, wherein
the lid member includes:
a first surface facing an inner surface of the housing when the liquid retainer is housed in the housing; and
a second surface opposite to the first surface, wherein
the liquid supply port includes:
a first opening provided on the first surface; and
a second opening provided on or near the second surface and having a size different from a size of the first opening.

17. The eyewear according to claim 16, wherein
the second opening is smaller than the first opening.

18. The eyewear according to claim 16, wherein
the lid member further includes a side portion connecting the first surface to the second surface,
the first surface includes a concave portion,
the first opening is provided on the concave portion of the first surface, and
the side portion includes an opening linking to the concave portion.

19. The eyewear according to claim 18, wherein
the side portion includes a side surface portion facing a face when the liquid retainer is housed in the housing and the frame is worn on the face,
the concave portion is elongated up to the side surface portion, and
the opening of the side portion is formed by the concave portion elongating up to the side surface portion.

20. The eyewear according to claim 13, wherein
the lid member is formed by a material having elasticity higher than elasticity of a material forming the liquid retainer.
